(19) United States
(12) Patent Application Publication
(10) Pub. No.: US 2026/0326494 A1
(43) Pub. Date: Oct. 22, 2026

(54) CONTROL SYSTEM FOR A VEHICLE

(71) Applicant: JAGUAR LAND ROVER LIMITED, Whitley, Coventry, Warwickshire (GB)

(72) Inventors: Jonathan DUNN, Whitley, Coventry, Warwickshire (GB); William CHADWICK, Whitley, Coventry, Warwickshire (GB); Ryan WESTON, Whitley, Coventry, Warwickshire (GB)

(21) Appl. No.: 19/494,662

(22) PCT Filed: Jun. 21, 2024
(86) PCT No.: PCT/EP2024/067478

§ 371 Date: Dec. 18, 2025

(30) Foreign Application Priority Data
Jun. 22, 2023 (GB) 2309410.5

(51) Int. Cl. B60G 17/016; B60W 10/22

(52) U.S. Cl. CPC B60G 17/016; B60W 10/22; B60G 2400/204; B60G 2400/41; B60G 2600/1877; B60W 2520/10; B60W 2530/20; B60W 2540/18

(57) ABSTRACT

A vehicle includes a plurality of wheels and an adaptive suspension system. A control system for the vehicle is configured to receive at least one input signal indicative of a size, or a change of size, of at least a first wheel of the plurality of wheels; determine if there has been an increase in the size of at least the first wheel in dependence on the at least one input signal; and, when it is determined that there has been an increase in the size of at least the first wheel, output a control signal- to reduce a maximum wheel travel of the adaptive suspension system.

### TECHNICAL FIELD

The present disclosure relates to a control system for a vehicle. Aspects of the invention relate to a control system for a vehicle, a vehicle comprising the control system, a method for controlling a vehicle and a non-transitory computer readable medium.

### BACKGROUND

Wheels of a vehicle are located within a wheel cavity or a wheel well. It is advantageous to minimise the size of the clearance between the wheel and the perimeter of the wheel cavity as this improves aerodynamics and design aesthetics.

It is an aim of the present invention to address one or more of the disadvantages associated with the prior art.

### SUMMARY OF THE INVENTION

Aspects and embodiments of the invention provide a control system for a vehicle, a vehicle comprising the control system, a method for controlling a vehicle and a non-transitory computer readable medium as claimed in the appended claims.

For the purpose of this disclosure, and unless otherwise stated, the wheel comprises a wheel and tyre assembly. The wheel may further comprise a traction aid such as a snow chain.

According to an aspect of the present invention there is provided a control system for a vehicle, the vehicle comprising a plurality of wheels and an adaptive suspension system, the control system comprising one or more processors, the one or more processors collectively configured to:
receive at least one input signal indicative of a size, or a change of size, of at least a first wheel of the plurality of wheels;
determine if there has been an increase in the size of at least the first wheel in dependence on the at least one input signal; and
when it is determined that there has been an increase in the size of at least the first wheel, output a control signal to reduce a maximum wheel travel of the adaptive suspension system.

An advantage of the control system is minimising, or preventing, damage to the vehicle or the wheels during movement of the suspension with larger wheels. The increase in wheel size may be due to the fitting of traction aids such as snow chains. An advantage is that the vehicle can be provided with a relatively tight clearance between the wheel and a perimeter of a wheel cavity, which improves aerodynamics and design aesthetics of the vehicle. The maximum wheel travel can be temporarily restricted during a period when the traction aids are fitted to the wheels of the vehicle.

Optionally, the vehicle comprises a steering system, and the control system is configured to:
receive at least one input signal indicative of a current steering angle of the steering system; and
the control signal to reduce the maximum value of wheel travel depends on the current steering angle of the steering system.

This has an advantage of reducing damage at steering angles where damage is most likely, such as steering angles near full front or near full rear lock.

Optionally, the control system is configured to, when it is determined that there has been an increase in the size of at least the first wheel, output a control signal to change a stiffness profile of the adaptive suspension system.

Optionally, the at least one input signal indicative of a size, or a change of size, of at least the first wheel of the vehicle is indicative of an outer diameter of at least the first wheel, or a change in the outer diameter of at least the first wheel.

Optionally, the at least one input signal indicative of a size, or a change of size, of at least the first wheel of the vehicle is indicative of a traction aid being fitted to at least the first wheel.

Optionally, the at least one input signal indicative of a size, or a change of size, of at least the first wheel of the vehicle is indicative of a width of at least the first wheel.

Optionally, the at least one input signal indicative of a size, or a change of size, of at least the first wheel of the vehicle comprises at least one of:
a user input indicating the size of at least the first wheel;
a user input indicating that a traction aid has been fitted to at least the first wheel.

Optionally, the at least one input signal indicative of a size, or a change of size, of the first wheel of the vehicle comprises:
an input signal indicating a rotation rate of at least the first wheel; and
a speed of the vehicle.

Optionally, the at least one input signal indicative of a size, or a change of size, of at least the first wheel of the vehicle comprises an audio input indicative of a sound of at least the first wheel moving on a surface.

Optionally, the control system is configured to process the audio input to determine if the audio is indicative of a traction aid fitted to the first wheel.

Optionally, the at least one input indicative of a size, or a change in size, of at least the first wheel of the vehicle comprises a video input or an image input of at least the first wheel.

Optionally, the control system is configured to receive at least one input signal indicative of a size, or a change of size, of each one of a plurality of wheels per axle of the vehicle.

Optionally, the control system is configured to receive at least one input signal indicative of a size, or a change of size, of each of the plurality of wheels of the vehicle.

Optionally, the vehicle has a first axle with a first wheel and a second wheel, and the control system is configured to receive at least one input signal indicative of a size, or a change of size, of the first wheel and receive at least one input signal indicative of a size, or a change of size, of the second wheel;
determine if there has been an increase in the size of the first wheel in dependence on the at least one input signal and determine if there has been an increase in the size of the second wheel in dependence on the at least one input signal; and
when it is determined that there has been an increase in the size of each of the first wheel and the second wheel, output a control signal to reduce a maximum wheel travel of the adaptive suspension system. This has an advantage that it does not erroneously reduce a maximum wheel travel, such as when one of the wheels has a flat tyre or experiences wheel slip.

Optionally, the control system is configured to determine if there has been a decrease in the size of at least the first wheel in dependence on the at least one input signal; and
when it is determined that there has been a decrease in the size of at least the first wheel, output a control signal to increase a maximum wheel travel of the suspension system.

This has an advantage of restoring the range of wheel travel, such as when wheel traction aids are removed from the wheels of the vehicle.

According to another aspect of the invention, there is provided a vehicle comprising the control system of the previous aspect.

According to another aspect of the invention, there is provided a method for controlling a vehicle, the vehicle comprising a plurality of wheels and an adaptive suspension system, the method comprising:
receiving at least one input signal indicative of a size, or a change of size, of at least a first wheel of the plurality of wheels; and
determining if there has been an increase in the size of at least the first wheel in dependence on the at least one input signal; and
when it is determined that there has been an increase in the size of at least the first wheel, outputting a control signal to reduce a maximum wheel travel of the adaptive suspension system.

According to another aspect of the invention, there is provided a non-transitory computer readable medium comprising computer readable instructions that, when executed by a processor, cause performance of the method.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to:
receive at least one input signal indicative of a size, or a change of size, of at least a first wheel of the plurality of wheels;
determine if there has been an increase in the size of at least the first wheel in dependence on the at least one input signal; and
when it is determined that there has been an increase in the size of at least the first wheel, output a control signal to reduce a maximum wheel travel of the adaptive suspension system.

According to another aspect of the invention, there is provided a control system for a vehicle, the vehicle comprising a plurality of wheels and an adaptive suspension system, the control system comprising one or more processors, the one or more processors collectively configured to:
receive at least one input signal indicative of a size, or a change of size, of at least a first wheel of the plurality of wheels;
output a control signal to control a maximum wheel travel of the adaptive suspension system based on the at least one input signal.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an example of a vehicle on which a control system according to embodiments of the invention may be implemented;

FIG. 2 schematically shows the control system and functional units of the vehicle;

FIG. 3 shows a wheel of the vehicle and movement of the wheel due to suspension travel;

FIG. 4 shows a range of steering angles for a pair of wheels of the vehicle;

FIG. 5 shows an example of the control system;

FIG. 6 shows a wheel travel envelope;

FIG. 7 shows an example of a wheel travel envelope for a vehicle with adaptive suspension;

FIG. 8 shows an example of a wheel travel envelope for a vehicle with adaptive steering;

FIG. 9 shows another example of a wheel travel envelope for a vehicle with adaptive steering;

FIG. 10 shows an example of a wheel travel envelope for a vehicle with adaptive suspension and adaptive steering;

FIG. 11 shows a flow diagram of an example of a method performed by the control system.

### DETAILED DESCRIPTION

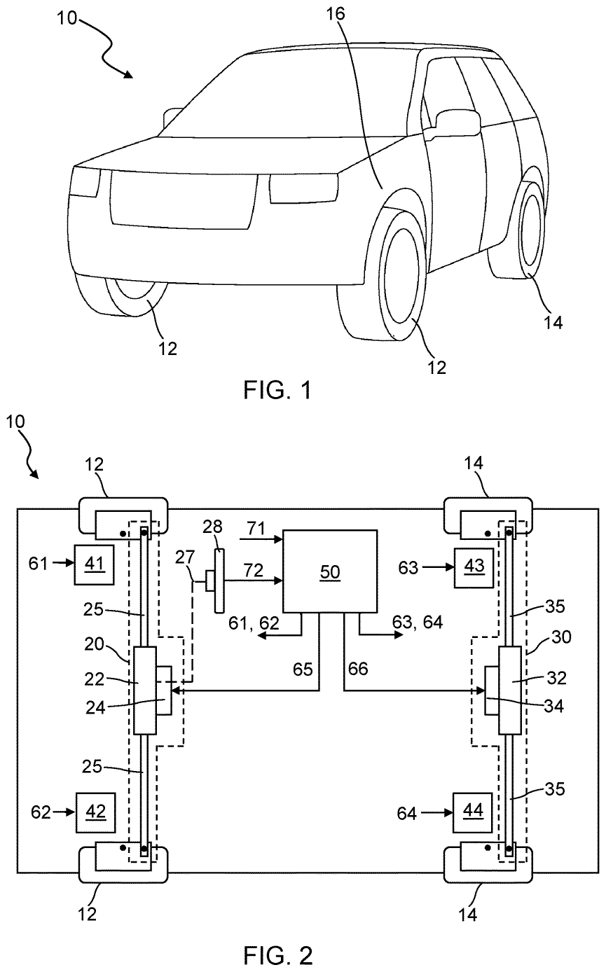

FIGS. 1 and 2 show an example of a vehicle 10 on which a control system according to embodiments of the invention may be implemented. The vehicle 10 may be a passenger vehicle or an automobile. The vehicle 10 may be intended for on-road use, such as a saloon vehicle, or may be intended for at least some off-road use, such as a sports utility vehicle (SUV) or a four-wheel drive (4×4) vehicle. The vehicle 10 may be a commercial vehicle.

In this example, the vehicle 10 comprises a pair of front wheels 12 and a pair of rear wheels 14. Wheels 12, 14 are mounted to a chassis of the vehicle by a suspension system 41, 42, 43, 44. The suspension system allows the wheels 12, 14 to move relative to the chassis. The suspension system allows the wheels to pass over an uneven surface or larger obstacles, and permits movement during cornering, braking and traction forces. A steering system 20 is provided to turn the front wheels 12. The vehicle 10 may also have a steering system 30 to turn the rear wheels 14. Some vehicles may only have the steering system 20 to turn the front wheels 12.

In this example, the front wheel steering system 20 comprises a steering rack 22 and linkages 25 which connect the steering rack 22 to the front wheels 12. As the steering rack 22 is moved, the linkages 25 and the front wheels 12 are turned to steer the vehicle. A rack and pinion steering system is one example of a steering system. The steering system 20 may be implemented in a different way, such as a steering box or a direct corner steering system.

In this example, the rear wheel steering system 30 comprises a steering rack 32 and linkages 35 which connect the steering rack 32 to the rear wheels 14. As the steering rack 32 is moved, the linkages 35 and the rear wheels 14 are turned to steer the vehicle. The rear wheel steering system 30 may be configured to turn the wheels 14 over a smaller range of angles compared to the front wheel steering system 20. The rear wheel steering system 30 may operate in a first mode in which it steers the rear wheels 14 in the opposite direction to the front wheels 12. This may be used at low vehicle speeds to help a larger vehicle to achieve a tighter turning circle. At certain times, the rear wheel steering system 30 may operate in a second mode in which it steers the rear wheels 14 in the same direction as the front wheels 12. This may be used at higher vehicle speeds.

There are various kinds of steering systems. In a power assisted steering system, there is a mechanical linkage 27 between the steering wheel 28 and the steering rack 22 and some assistance is provided to reduce the force required to steer the wheels. Power assisted steering systems may use a hydraulic system to provide assistance (called hydraulic power assisted steering) or an electrical system to provide assistance (called electric power assisted steering (EPAS)). For a power assisted steering system, blocks 24, 34 represent a unit which provides assistance to move the steering rack 22, 32, such as an electric motor in an EPAS system.

A further type of steering system is a steer-by-wire steering system. This removes the mechanical linkage 27 between the steering wheel and steering column 28 and the steering rack 22. A sensor detects a position of the steering wheel 28. Controller 50 receives an input indicating the sensed position of the steering wheel. A drive 24, 34, such as an electric motor, is provided to move the steering rack 22, 32. The controller 50 provides a steering control output to drive 24, 34, to move the steering rack 22, 32 and turn the wheels 12, 14. The steer-by-wire steering system can also be used in vehicles with an autonomous drive mode, in which direction of the vehicle is controlled autonomously without a need for driver input via the steering wheel 28.

The vehicle 10 comprises a control system with a controller 50. Controller 50 is configured to receive an input 72 from the steering column indicating a steering direction of the vehicle. Controller 50 is also configured to receive at least one input 71 indicative of a size, or a change of size, of at least one of the wheels 12, 14 of the vehicle. Controller 50 is configured to output a control signal 65 to control the front steering system 20 and to output a control signal 66 to control the rear steering system 30. Controller 50 is configured to output control signals 61-64 to control the suspension system 41-44.

For clarity, FIG. 1 omits other parts of the vehicle which are not directly relevant to the present disclosure. For example, the vehicle comprises a powertrain which includes an electric motor/generator, an internal combustion engine, or a hybrid system as a source of propulsion. The powertrain comprises a driveline which connects the motor or engine to the wheels 12, 14.

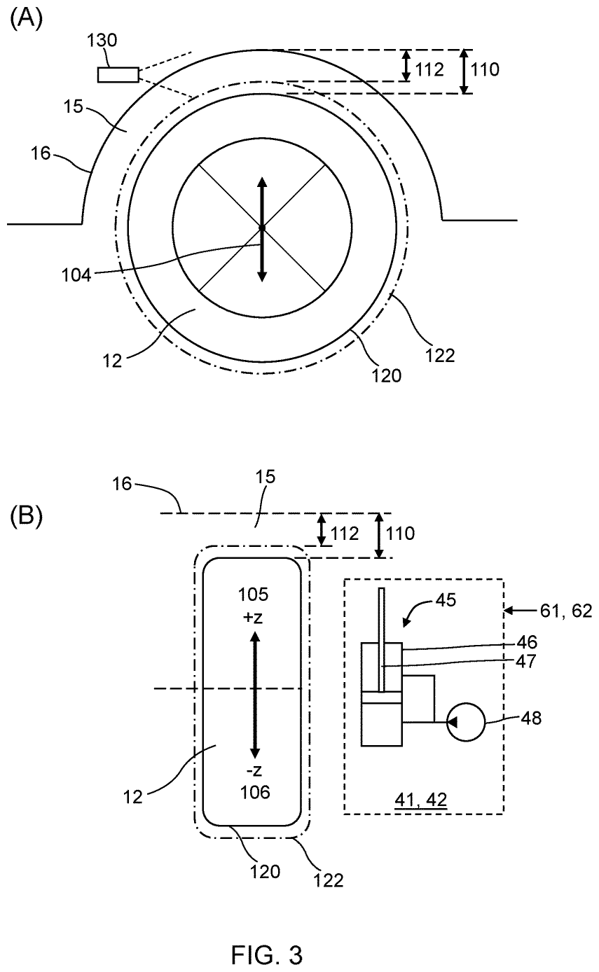

FIG. 3 shows an example of one of the wheels 12 of the vehicle 10 and part of the vehicle body 16 adjacent to wheel 12. FIG. 3(A) shows a side view of the wheel and body. FIG. 3(B) shows a front/rear view of the wheel and body. The wheel 12 is located within a space called a wheel cavity 15 or a wheel well. The wheel cavity 15 is bounded by part of the body 16 (and chassis) of the vehicle. The wheel cavity 15 is designed to be large enough to accommodate the range of movement of the wheel expected during use of the vehicle. The size of the wheel cavity 15 is based on the size of the wheel (diameter, width). The size of the cavity is based on the expected driving conditions for the vehicle. For example, a saloon road vehicle is expected to normally drive on paved roads and therefore have a fairly limited range of movement, while a SUV or 4×4 vehicle is expected to drive off-road and therefore have a larger range of movement. There are various design factors for the wheel cavity 15. On the one hand, the wheel cavity 15 should be sufficiently large to allow free movement of the wheel 12 and minimise, or avoid, clashes between the wheel 12 and other parts of the vehicle.

On the other hand, it is advantageous to minimise the size of the wheel cavity 15 as this improves aerodynamics and design aesthetics. A wheel cavity 15 which is well-matched to a particular size of wheel is unable to accommodate an increase in wheel diameter or width. Part of the wheel cavity 15 may be lined by a wheel arch liner. A wheel arch liner is a curved structure (typically plastic) which protects the body from any objects thrown from the wheel.

FIG. 3 shows two possible wheel sizes 120, 122. Wheel size 122 is greater than wheel size 120. For the first wheel size 120, there is a first vertical clearance 110 between the wheel 120 and the body. For the second (larger) wheel size 122, there is a second vertical clearance 112 between the wheel 122 and the body. The second vertical clearance 112 is less than the first vertical clearance 110. The second (larger) wheel size 122 may be due to a user fitting a traction aid (e.g. snow chains) to a tyre. Alternatively, the second (larger) wheel size 122 may be due to a user fitting a new tyre and rim which are larger than an existing tyre and rim. The second wheel size 122 can have: (i) an increased diameter; (ii) an increased width; or (iii) an increased diameter and increased width (as shown in FIG. 3(B)). Traction aids typically fit around the outside of a tyre, extending across the full width of the tyre tread and alongside the sidewall of the tyre. Therefore, fitting a traction aid to a wheel will increase diameter and width of the wheel. Some known types of traction aids include: snow chains which fully surround the tread and sidewall of the tyre; snow chains (called half chains) which only cover the tread of the tyre; snow socks; studded tyres; metallic spikes protruding from a tyre; snow cleats or claws.

The larger wheel size 122 reduces clearance between the wheel 12 and the body 16 of the vehicle. This can cause problems when the user drives the vehicle. The larger wheels may contact part of the body, such as the wheel arch or wheel arch liner, under certain driving conditions. For example, the larger wheels may contact part of the body at large steering angles or when the suspension rides over obstacles. This can damage the tyres, and may damage the body of the vehicle.

In one embodiment, the controller 50 is configured to reduce a maximum steering lock angle of the steering system when there is an increase in wheel size. In one embodiment, the controller 50 is configured to reduce the maximum value of wheel travel when there is an increase in wheel size.

FIG. 3(B) schematically shows an adaptive suspension system 41, 42 associated with each of the wheels 12. There are various types of adaptive suspension system. One type of suspension system uses a mechanical spring and a damper (shock absorber). The damper may be adaptive. That is, the firmness of the damper may be controlled during operation of the vehicle to change the behaviour of the suspension. The suspension system may have an end stop which limits travel of the suspension beyond a physical point. The end stop may be adaptive, to vary the position of the end stop. For example the position of the end stop may be controlled to reduce the maximum range of movement of the suspension. The adaptive suspension system may use an adaptive damper and/or an adaptive end stop.

Another type of suspension system, shown in FIG. 3(B), comprises an actuator or air spring 45. The air spring 45 comprises a fluidic chamber 46 and a piston 47 which moves within the chamber 46. A pump 48 is configured to selectively pump fluid (air) into compartments of the fluidic chamber. This can control parameters such as: firmness of the suspension; a range of suspension travel; height of the suspension (i.e. how high the body of the vehicle is supported with respect to the wheel 12).

Movement of the wheel 12 in the vertical direction is called wheel travel. From a normal rest position, the wheel can move:
(i) upwards from the rest position (positive z-direction) 105. This is called bump travel. Bump travel compresses a spring/damper assembly or an air spring of the suspension system 41 associated with that wheel.
(ii) downwards from the rest position (negative z-direction) 106. This is called rebound travel. Rebound travel extends a spring/damper assembly or an air spring of the suspension system 41 associated with that wheel.

The vehicle also comprises an adaptive suspension system 43, 44 associated with each of the rear wheels 14. This can operate in the same, or similar, way as described for the front wheels 12.

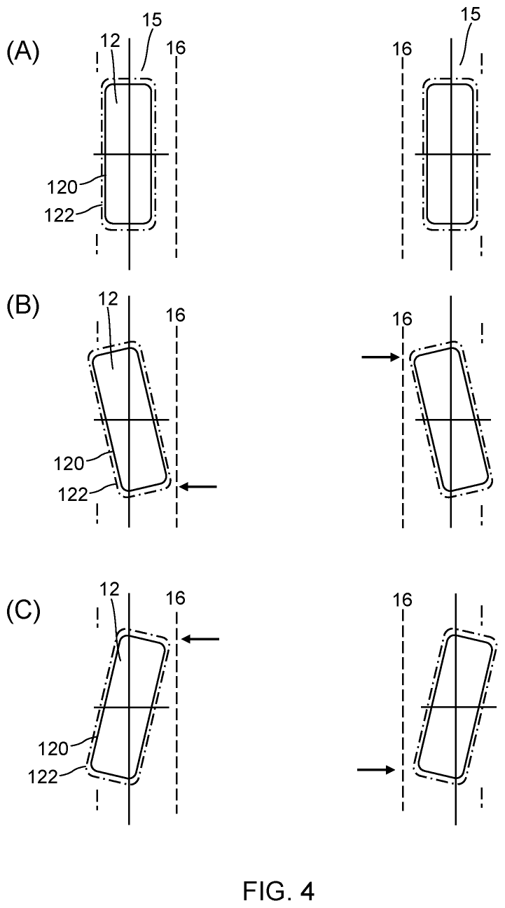

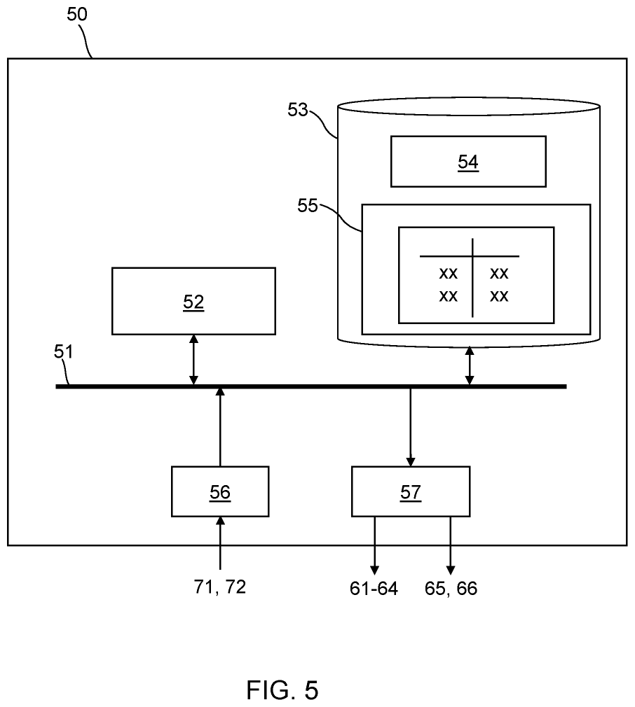

FIG. 4 shows a set of plan views of for the pair of wheels 12. Each of the wheels 12 is steerable within a respective wheel arch cavity 15. The wheel arch cavity 15 is bounded, on the innermost side of the vehicle, by an inner part of the body 16 and, on the outermost side, by an outer part of the body 16. FIG. 4(A) shows the wheels 12 in a rest position, for forward travel. FIG. 4(B) shows the wheels 12 steered fully to the left, i.e. maximum left lock. FIG. 4(C) shows the wheels 12 steered fully to the right, i.e. maximum right lock. For each view, two wheel sizes 120, 122 are shown. In this example, wheel size 122 has a larger diameter, and a larger width, compared to wheel size 120. When the wheels 12 are positioned at maximum lock, one part of the wheel is positioned closely to the body 16 of the vehicle. An increase in the size of the wheel (diameter and/or width of the wheel) reduces the clearance between the wheel 12 and the body 16 and therefore increases the risk of contact between the wheel and the body.

In FIG. 4(B), the left hand wheel is in full rear lock, i.e. the rear shoulder of the wheel is closest to the inside body 16 of the vehicle. Another term for “rear lock” is “back lock”. The right hand wheel is in full front lock, i.e. the front shoulder of the wheel is closest to the inside body 16 of the vehicle. In FIG. 4(C), the left hand wheel is in full front lock, i.e. the front shoulder of the wheel is closest to the inside body 16 of the vehicle, and the right hand wheel is in full rear lock, i.e. the rear shoulder of the wheel is closest to the inside body 16 of the vehicle.

FIG. 5 schematically shows the control system. The control system comprises one controller 50, although it will be appreciated that this is merely illustrative. The control system may comprise a plurality of controllers which are electrically connected together, and collectively perform the described functionality. The controller 50 comprises at least one processor 52 which may be any type of processor for executing instructions to control the operation of the system. The processor 52 is electrically connected to other components of the controller via one or more buses 51. Processor-executable instructions 54 may be provided using any data storage device or computer-readable media, such as memory 53. The processor-executable instructions 54 comprise instructions for implementing the functionality of the described methods. The storage/memory 53 is of any suitable type such as non-volatile memory, a magnetic or optical storage device. The processor 52 is configured to access the memory 53 and execute the stored instructions 54. Memory 53, or a separate memory/storage stores data 55 used by the processor 52. Data 55 may comprise data which maps values of wheel size (or maps values of one or more input signals indicative of wheel size) to maximum ranges of steering angle. Data 55 may comprise data which maps values of wheel size (or maps values of one or more input signals indicative of wheel size) to maximum ranges of wheel travel, which the control system 50 can use to limit steering angle. Data 55 may comprise data which maps values of steering angle to values of wheel travel, which the control system 50 can use to limit wheel travel.

The controller 50 comprises an input interface 56. The input interface 56 is configured to receive one or more input signals 53. The controller 50 comprises an output interface 57. The output interface 57 is configured to output outputs, such as: the control signals 61-64 to control the suspension system and the control signals 65, 66 to control the steering system.

The controller 50 receives various input signals 71, 72. The input signals may comprise an input signal 72 indicative of a steering demand. For example, a sensor associated with a steering column detects rotation of the steering column (and therefore rotation of the steering wheel 28).

The input signals may comprise one or more input signals indicative of a size, or a change of size, of at least one of the wheels 12, 14. There are various possible ways of detecting a size of a wheel, or a change in size of a wheel. Some examples of possible inputs are described in more detail below. Possible input signals include one or more of: an input from a user interface of the vehicle; an input from a sensor which detects rotational speed of a wheel; an input from a sensor which detects longitudinal velocity of the vehicle; a microphone which detects an audio signal representing a sound of the wheel on a road surface; a camera which acquires an image of the road surface and/or wheel; an input from a Stability Control System (SCS) or a Traction Control System (TCS) which indicates wheel slip.

The controller 50 outputs control signals 61-64 to control operation of the suspension system and the control signals 65, 66 to control the steering system. The controller 50 is configured to use one or more of the input signals 71, 72 and stored data, to generate output signals 61-66.

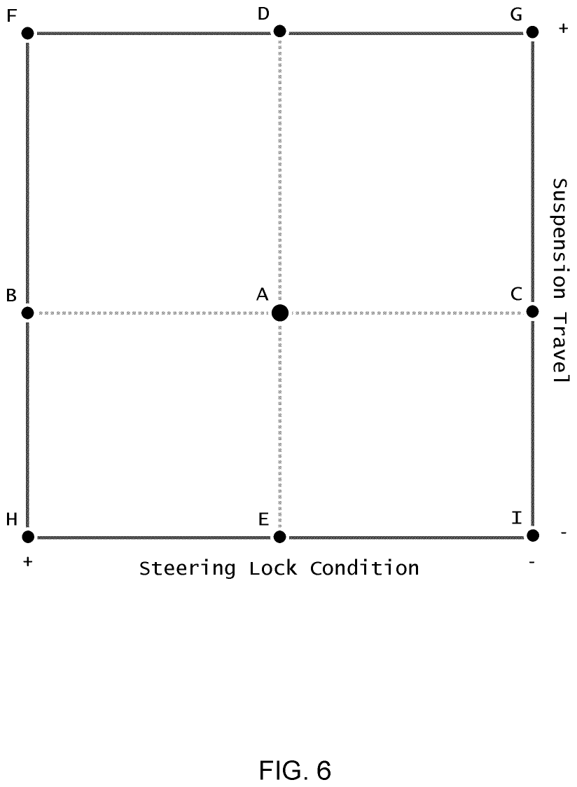

FIGS. 6 to 10 show examples of wheel travel envelope diagrams. The wheel travel envelope diagrams show a range of movement of a wheel, with:
(i) the x-axis of the drawing representing steering angle (or steering rack travel). This is the range of movement shown in FIG. 4; and
(ii) the y-axis of the drawing representing suspension travel or wheel travel. This is the range of vertical (z-axis) movement shown in FIG. 3(B).

On the x-axis, the positive direction (+) represents movement of the wheel towards front lock (i.e. the wheel position shown in FIG. 4(B), right hand drawing), and the negative direction (−) represents movement of the wheel towards rear lock (i.e. the position shown in FIG. 4(C), right hand drawing).

FIG. 6 shows a generalised wheel travel envelope. The labelled points represent:
A: resting condition;
B: full front lock (i.e. the wheel position shown in FIG. 4(B), right hand drawing);
C: full rear lock (i.e. the position shown in FIG. 4(C), right hand drawing);
D: full bump;
E: full rebound;
F: full bump and front lock;
G: full bump and rear lock;
H: full rebound and front lock;
I: full rebound and rear lock.

In FIG. 6, the wheel travel envelope is a rectilinear box. This is one possible example. The envelope may have other shapes. For example, it may allow a larger amount of wheel travel in the bump direction and/or the rebound direction for a limited range of steering angles around the rest (straight ahead) steering position.

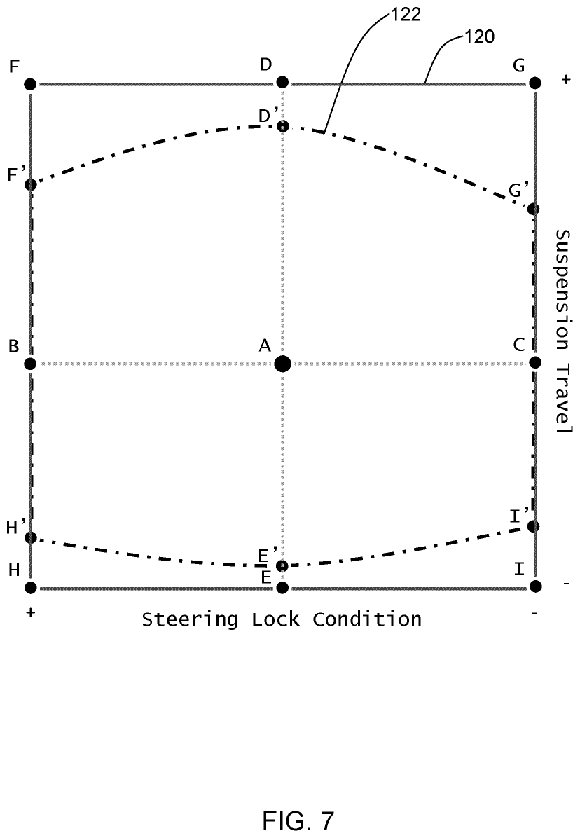

FIGS. 7 to 10 show wheel travel envelopes where the amount of wheel travel and/or steering angle has been restricted compared to FIG. 6. The controller 50 may control the suspension system and/or the steering system of the vehicle to change between the wheel travel envelope of FIG. 6 to one of the wheel travel envelopes of FIGS. 7 to 10.

FIG. 7 shows an example of a wheel travel envelope for a vehicle with adaptive suspension. Labelled points A-I are the same as shown for FIG. 6. The envelope shows the following reduced system limits:
D′: reduced maximum bump;
E′: reduced maximum rebound;
F′: maximum bump and front lock;
G′: maximum full bump and rear lock;
H′: maximum rebound at full front lock;
I′: maximum rebound at full rear lock.

The envelope shows the same full range of steering angles but with reduced wheel travel compared to the reference envelope for wheel size 120. The wheel can only move to positions F′ and G′, compared to positions F and G for the reference envelope. In this example, the range of wheel travel is reduced at all steering angles. The amount of permitted wheel travel is greatest when the wheel is straight (points D′, E′). The amount of permitted wheel travel is progressively reduced as the wheel is steered left or right from the straight running position. In this example, the reduction in the amount of wheel travel is non-linear, i.e. the rate of reduction in wheel travel increases as the wheel is steered towards the maximum lock positions. In other examples, the reduction in the amount of wheel travel is non-linear. The reduction in the amount of wheel travel prevents, or minimises, contact between the larger wheel 122 and body of the vehicle.

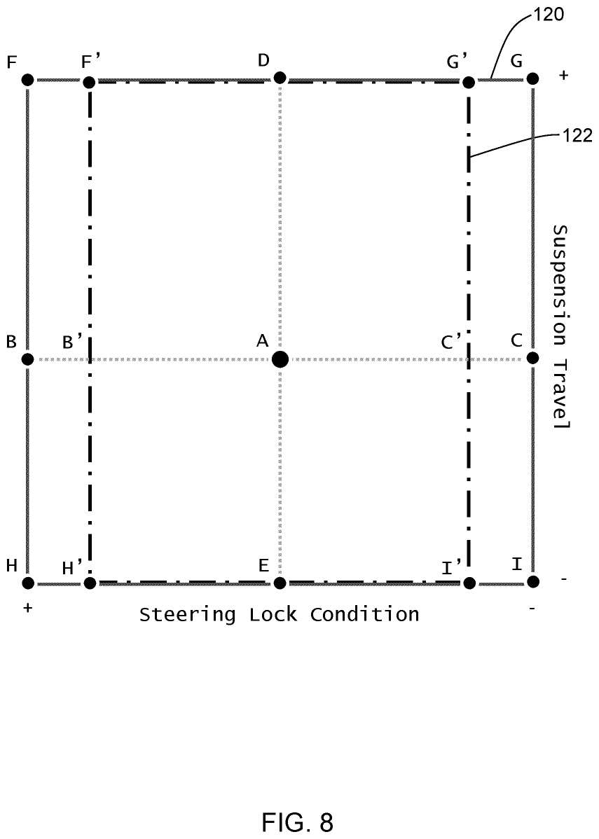

FIG. 8 shows a first example of a wheel travel envelope for a vehicle with adaptive steering. Labelled points A-I are the same as shown for FIG. 6. The envelope shows the following reduced system limits:
B′: reduced front lock;
C′: reduced rear lock;
F′: maximum bump at full front lock;
G′: maximum full bump at full rear lock;
H′: maximum rebound at full front lock;
I′: maximum rebound at full rear lock.

The envelope shows the same full range of wheel travel but with a reduced range of steering angles compared to the reference envelope for wheel size 120. The wheel can only be steered to positions B′ and C′, compared to positions B and C for the reference envelope. The reduction in the range of steering angles prevents, or minimises, contact between the larger wheel 122 and body of the vehicle. The range of steering angles may be the same in the front lock (+) and rear lock (−) directions. Alternatively, the range of steering angles may be different in the front lock (+) and rear lock (−) directions.

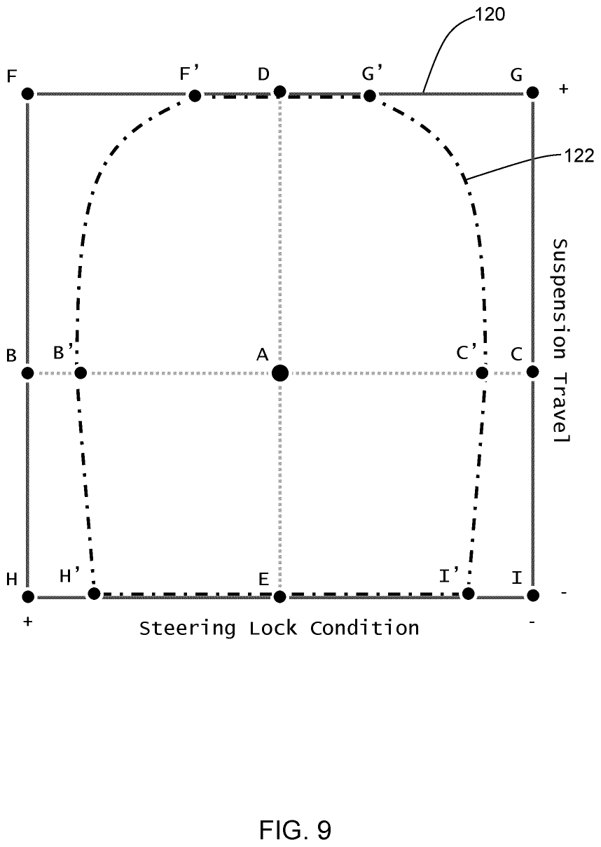

FIG. 9 shows a second example of a wheel travel envelope for a vehicle with adaptive steering. Labelled points A-I are the same as shown for FIG. 6. The envelope shows the following reduced system limits:
B′: reduced front lock;
C′: reduced rear lock;
F′: maximum bump at full front lock;
G′: maximum full bump at full rear lock;
H′: maximum rebound at full front lock;
I′: maximum rebound at full rear lock.

Similar to FIG. 8, the envelope shows a reduced range of steering angles compared to the reference envelope for wheel size 120. The wheel can only be steered to positions B′ and C′, compared to positions B and C for the reference envelope. The range of permitted steering angles is a function of wheel travel. As the wheel moves away from rest in the bump direction, the range of permitted steering angles is reduced. At maximum bump, the range of permitted steering angles is restricted to F′ to G′. As the wheel moves away from rest in the rebound direction, the range of permitted steering angles is reduced. At maximum rebound, the range of permitted steering angles is restricted to H′ to I′. The envelope for wheel size 122 may have a different shape to the one shown in FIG. 9. For example, the envelope may allow a wider range of steering angles at maximum bump, or at maximum rebound, compared to the values shown here. The reduction in the range of steering angles prevents, or minimises, contact between the larger wheel 122 and body of the vehicle.

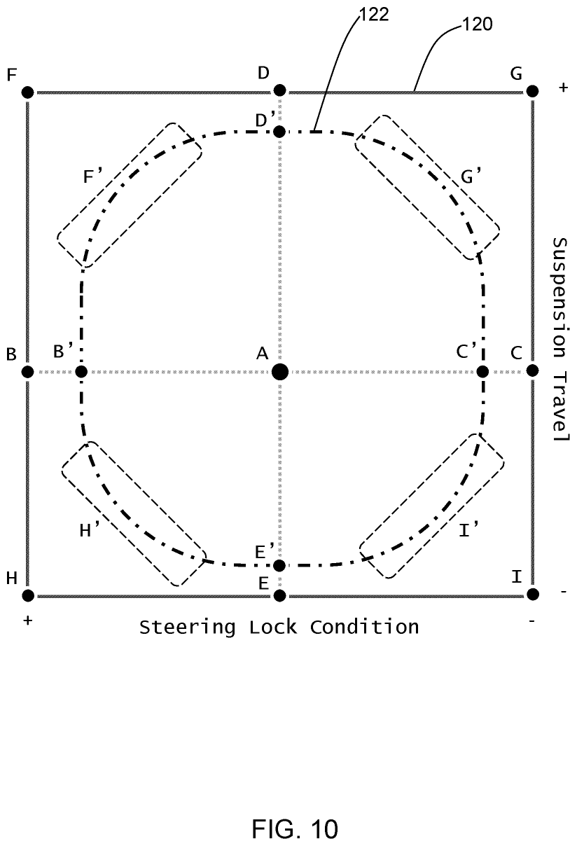

FIG. 10 shows an example of a wheel travel envelope for a vehicle with adaptive suspension and adaptive steering. Labelled points A-I are the same as shown for FIG. 6. The envelope shows the following reduced system limits:
B′: full front lock (i.e. the wheel position shown in FIG. 4(B), right hand drawing);
C′: full rear lock (i.e. the position shown in FIG. 4(B), left hand drawing);
D′: reduced maximum bump;
E′: reduced maximum rebound;
F′: maximum bump and front lock;
G′: maximum full bump and rear lock;
H′: maximum rebound at full front lock;
I′: maximum rebound at full rear lock.

The envelope for wheel size 122 is a combination of the envelopes shown in previous drawings. The envelope shows a reduced range of steering angles compared to the reference envelope for wheel size 120. The wheel can only be steered to positions B′ and C′, compared to positions B and C for the reference envelope. As the steering angle increases, the range of permitted bump suspension travel reduces. As the steering angle increases, the range of permitted rebound suspension travel reduces. The range of permitted wheel travel can be dependent on steering angle. For example, at a steering angle X, the permitted wheel travel is a function of angle X. The envelope for wheel size 122 may have a different shape to the one shown in FIG. 10. For example, the envelope may allow a wider range of steering angles at maximum bump or at maximum rebound. The reduction in the range of wheel travel and steering angles prevents, or minimises, contact between the larger wheel 122 and body of the vehicle.

In the wheel travel envelopes shown in FIGS. 8, 9 and 10, the controller 50 restricts steering angle when there is an increase in wheel size. The controller 50 selects a range of steering angles according to the new wheel size. In the wheel travel envelopes shown in FIGS. 7, 9 and 10, the controller 50 restricts wheel travel when there is an increase in wheel size. The controller 50 selects a range of wheel travel according to the new wheel size.

In a vehicle with a steer-by-wire steering system, the controller 50 outputs a control signal 65 to an electric motor 24 to move steering rack 22. The controller 50 only permits the electric motor 24 to move the steering rack within the range of steering angles for the new wheel size.

In a vehicle with a conventional power-assisted steering system, there is a mechanical linkage 27 between the steering wheel 70 and the steering rack 22. The controller 50 can control an amount of assistance based on the steering angle. For example, if the range of permitted steering angles is X degrees each side of the rest (straight ahead) position, the power-assisted steering system is configured to: (i) provide assistance to steering when the steering angle is less than X degrees each side of rest, and (ii) not provide assistance, or resist movement of the steering, when the steering angle is more than X degrees each side of rest. The controller 50 may vary the assistance profile, so that the steering becomes progressively heavier as it nears the maximum permitted steering angle. The controller 50 can control the steering angle (or % of steering rack travel) at which power assistance is reduced, or turned off, via control signal 65.

### Detecting Wheel Size or a Change in Wheel Size

Some ways of detecting wheel size, or a change in wheel size, will now be described.

### User Interface

One possible way is by manual input through a user interface of the vehicle. The user interface of the vehicle can allow a user to indicate that they have fitted a traction aid, or a particular type of traction aid (e.g. snow chains) to a wheel. The control system can determine, from this information, that the wheel has increased in size as the traction aid will increase the diameter of the wheel. The user interface may allow the user to input the intent to fit traction aids. The control system may then raise the suspension to facilitate easy fitting of snow chains and after fitting re-configure the steering and/or suspension as herein described.

The user interface of the vehicle may be configured to allow a user to indicate the size of the tyres fitted to the vehicle. The user interface may display a list of typical tyre sizes for the vehicle (e.g. 255/55 R19; 265/45 R21; etc.), and allow the user to select the size of the tyres fitted to the vehicle. Alternatively, the user interface may allow the user to directly enter the tyre size. The control system can compare the tyre size entered by the user with any previously stored size information to determine whether there has been an increase in the size of the wheel.

### Forward Velocity Vs Wheel Rotation

A sensor detects rotational speed of a wheel. Another sensor detects longitudinal velocity of the vehicle. Using both of these measurements (e.g. a division of the longitudinal velocity by the rotational speed) indicates diameter of the wheel (i.e. the tyre, or a combination of the tyre plus any traction aid fitted to the tyre). Longitudinal velocity of the vehicle may be detected in many known ways, such as GPS, radar, or cameras. For example, a camera may track an object or marking on the road through a number of frames and thereby calculate the vehicle speed.

### Audio/Video

A microphone detects an audio signal representing a sound of the wheel on a road surface. When a traction aid is fitted to a tyre, it makes a distinctive sound. Similarly, certain types of tyre (e.g. summer tyre, winter tyre) have a particular sound. The control system analyses the audio signal to determine if a particular sound, indicative of a traction aid, is present. The control system can determine, from this information, that the wheel has increased in size as traction aid will increase the diameter of the wheel.

A camera acquires an image of the wheel. The camera may be positioned in the wheel arch cavity (130, FIG. 3), in a door mirror with a field of view towards the ground, including one of the front wheels 12). The control system analyses the image to determine a size of the wheel currently present in the wheel arch cavity. For example, the control system may determine what portion of the wheel arch cavity is still vacant when the suspension system is at rest. The control system may determine diameter of the wheel (including any traction aid) from the image. The control system may determine width of the wheel (including any traction aid) from the image. The control system may determine that a traction aid has been fitted to the wheel, such as by analysing an image of the wheel acquired by the camera and recognising a traction aid.

### Wheel Slip Signature

The control system implements a Stability Control System (SCS) or a Traction Control System (TCS) which determines wheel slip. When the vehicle accelerates or changes direction, the tyre (and any traction aids, if fitted) will deflect and slip. The characteristics of those deflections and slip events will be different depending on the properties of the tyre fitted and any traction aids. By measuring these events, and comparing to stored data representing measurements of known tyres/traction aids, it is possible for the control system to determine that a traction aid is fitted. The control system can determine, from this information, that the wheel has increased in size as the traction aid will increase the diameter of the wheel.

The control system 50 may use one, or a combination, of the above to determine wheel size.

The controller may acquire information about wheel size, or change in wheel size, for each wheel of the vehicle. The controller may acquire information about wheel size, or change in wheel size, for each wheel of an axle of the vehicle (e.g. front axle left wheel and front axle right wheel). The controller may determine that there has been a change in wheel size if both wheels indicate the same (or similar) result. This can help to prevent an incorrect determination of a change in wheel size when there has been a change in one of the wheels, such as a flat tyre, or left and right hand wheels experiencing different levels of traction.

Alternatively, the controller may acquire information about wheel size, or change in wheel size, for one wheel per axle of the vehicle. The vehicle will typically have the same size of tyre fitted to every wheel. Traction aids may be fitted to every wheel, or to the wheels on one of the axles.

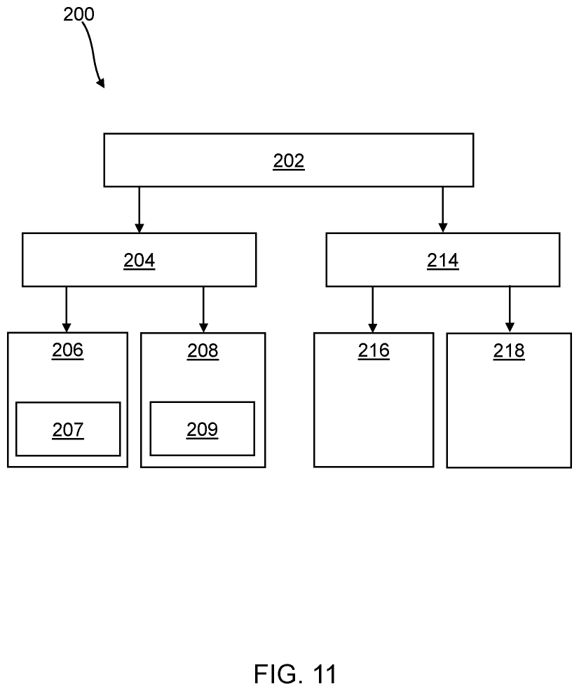

FIG. 11 shows a method of operating the controller 50 for use in the vehicle 10. The method 200 may be performed by the controller 50. In particular, the memory 53 may comprise computer-readable instructions 54 which, when executed by the processor 52, perform the method 200.

At block 202 the controller 50 receives at least one input signal indicative of a size, or a change of size, of the first wheel of the vehicle. For clarity, the method describes receiving an input signal relating to a first wheel of the vehicle. The method may also receive input signals relating to other wheels of the vehicle. As described above, the at least one input signal may indicate an outer diameter of the first wheel, or a change in the outer diameter of the first wheel. Additionally, or alternatively, the at least one input signal may indicate a width of the first wheel, or a change in the width of the first wheel.

At block 204 the controller 50 determines if there has been an increase in the size of the first wheel. Block 204 can make this determination in dependence on the at least one input signal. For some input signals, the controller 50 can readily determine that there has been an increase in the size of the wheel. For example, if the controller 50 receives an input, via the user interface, that snow chains have been fitted to the wheels, the controller 50 can determine that the size of the wheels has increased. For some input signals, the controller 50 can use stored data of a previous state of the vehicle, and determine if there has been an increase in the size of the wheel. For example, if the controller 50 receives an input indicating the current size of the wheel, it can use stored data indicating a previous wheel size, and determine if there has been an increase in the wheel size. Block 204 may make the determination in dependence on a plurality of input signals. The controller may use machine learning to learn a set of input conditions which indicate that there has been an increase in the size of the wheel.

For a method which controls maximum steering lock angle, the controller proceeds to block 206 when block 204 determines there has been an increase in the size of the first wheel. For a method which controls maximum wheel travel, the controller 50 proceeds to block 208 when block 204 determines there has been an increase in the size of the first wheel. For a method which controls maximum steering lock angle and maximum wheel travel, the controller 50 proceeds to blocks 206 and 208 when block 204 determines there has been an increase in the size of the first wheel.

At block 206 the controller 50 outputs a control signal to reduce a maximum steering lock angle of the steering system. The controller determines a maximum value of the steering lock angle based on the size of the wheel. There is an inverse relationship between maximum value of the steering lock angle and wheel size. That is, as wheel size increases, there is a reduction in the maximum value of the steering lock angle. The wheel travel envelope may be changed in the manner shown for wheel 122 in the examples of FIG. 8, 9 or 10. The maximum steering angle for wheel size 122 is reduced compared to the maximum steering lock angle for wheel size 120. The control signal 65 output by the controller 50 may directly control the steering system 20 of the vehicle and cause the steering system to operate with the new maximum steering lock angle. Alternatively, the control signal 65 output by the controller 50 may instruct another controller (not shown) of the steering system to operate with the new maximum steering lock angle.

At block 208 the controller 50 outputs a control signal to reduce a maximum wheel travel of the suspension system. The controller determines a maximum value of wheel travel based on the size of the wheel. There is an inverse relationship between maximum value of wheel travel and wheel size. That is, as wheel size increases, there is a reduction in the maximum value of wheel travel. The wheel travel envelope may be changed in the manner shown in FIG. 7 or FIG. 10. This option can be implemented in a vehicle which allows dynamic control of the adaptive suspension, such as control of the firmness of the air springs (45, FIG. 3) or control of bump stops or other devices which limit the amount of travel of the wheels. The controller may control a stiffness profile of the adaptive suspension system. For example, if the maximum wheel travel is reduced, the stiffness profile can be made firmer.

One way of controlling wheel travel is to dynamically control the amount of wheel travel based on the current steering angle. At block 209, the controller 50 receives at least one input signal indicative of a current steering angle. In dependence on the input signal indicative of the current steering angle, the controller 50 outputs a control signal to control the maximum wheel travel. In this way, the maximum wheel travel is controlled based on the current steering angle. As shown in FIG. 7 and FIG. 10, wheel travel is reduced as the wheel is steered towards the maximum lock positions.

In some vehicles, the control system controls maximum steering lock angle and maximum wheel travel. The controller 50 proceeds to blocks 206 and 208. FIG. 10 shows control of maximum steering lock angle and maximum wheel travel. The maximum steering angle for wheel size 122 is reduced compared to the maximum steering angle for wheel size 120. Also, the maximum wheel travel for wheel size 122 is controlled (reduced) based on the current steering angle. This option can be implemented in a vehicle which allows dynamic control of the adaptive suspension, such as control of the firmness of the air springs (45, FIG. 3) or control of bump stops or other devices which limit the amount of travel of the wheels.

At block 214 the controller 50 determines if there has been a decrease in the size of the first wheel in dependence on the at least one input signal. For some input signals, the controller 50 can readily determine that there has been a decrease in the size of the wheel. For example, if the controller 50 receives an input, via the user interface, that snow chains have been removed from the wheels, the controller 50 can determine that the size of the wheels has decreased. For some input signals, the controller 50 can use stored data of a previous state of the vehicle, and determine if there has been a decrease in the size of the wheel. For example, if the controller 50 receives an input indicating the current size of the wheel, it can use stored data indicating a previous wheel size, and determine if there has been a decrease in the wheel size.

For a control system which controls steering angle, the controller 50 proceeds to block 216 when block 214 determines there has been a decrease in the size of the first wheel. The controller 50 outputs a control signal to increase a maximum steering lock angle of the steering system.

For a control system which controls wheel travel, the controller 50 proceeds to block 218 when block 204 determines there has been a decrease in the size of the first wheel. The controller 50 outputs a control signal to increase a maximum wheel travel of the suspension system.

Optionally, at block 207, the controller determines a maximum value of the steering lock angle based on a current value of a dynamic quantity of the vehicle. In the example shown in FIG. 9, the controller 50 receives at least one input signal indicative of a current wheel travel of the suspension. In dependence on the input signal indicative of the current wheel travel of the suspension system, the controller 50 outputs a control signal to control the maximum steering angle. In this way, the maximum steering angle is controlled based on the current wheel travel. The controller may determine a maximum value of the steering lock angle based on a current value of a different dynamic quantity of the vehicle.

For clarity, the above method only refers to “a first wheel”. The controller 50 may receive an input for one wheel of an axle (e.g. one of the front wheels 12), or may receive an input for each wheel per axle (e.g. both of the front wheels 12). The controller 50 may control maximum steering lock angle for the wheels on a single axle of the vehicle, or for the wheels on each axle of the vehicle. The controller 50 may control maximum wheel travel for each of the wheels of the vehicle, or a subset of the set of wheels of the vehicle.

The vehicle described has four wheels. It will be understood that the control system may be implemented on vehicles with a different number of wheels.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

It will be appreciated that various changes and modifications can be made to the present invention without departing from the scope of the present application.

1. A control system for controlling an adaptive suspension system of a vehicle, the vehicle comprising a plurality of wheels, the control system comprising one or more processors, the one or more processors collectively configured to:
receive at least one input signal indicative of a size, or a change of size, of at least a first wheel of the plurality of wheels;
determine if there has been an increase in the size of at least the first wheel in dependence on the at least one input signal; and
when it is determined that there has been an increase in the size of at least the first wheel, output a control signal to reduce a maximum wheel travel of the adaptive suspension system.

2. The control system of claim 1 wherein the vehicle comprises a steering system, and wherein the one or more processors are further configured to:
receive at least one input signal indicative of a current steering angle of the steering system; and
the control signal to reduce the maximum value of wheel travel depends on the current steering angle of the steering system.

3. The control system of claim 1, wherein the one or more processors are further configured to, when it is determined that there has been an increase in the size of at least the first wheel, output a control signal to change a stiffness profile of the adaptive suspension system.

4. The control system of claim 1, wherein the at least one input signal indicative of a size, or a change of size, of at least the first wheel of the vehicle is indicative of an outer diameter of at least the first wheel, or a change in the outer diameter of at least the first wheel.

5. The control system of claim 1, wherein the at least one input signal indicative of a size, or a change of size, of at least the first wheel of the vehicle is indicative of a traction aid being fitted to at least the first wheel.

6. The control system of claim 1, wherein the at least one input signal indicative of a size, or a change of size, of at least the first wheel of the vehicle is indicative of a width of at least the first wheel.

7. The control system of claim 1, wherein the at least one input signal indicative of a size, or a change of size, of at least the first wheel of the vehicle comprises at least one of:
a user input indicating the size of at least the first wheel;
a user input indicating that a traction aid has been fitted to at least the first wheel.

8. The control system of claim 1, wherein the at least one input signal indicative of a size, or a change of size, of the first wheel of the vehicle comprises:
an input signal indicating a rotation rate of at least the first wheel; and
a speed of the vehicle.

9. The control system of claim 1, wherein the at least one input signal indicative of a size, or a change of size, of at least the first wheel of the vehicle comprises:
an audio input indicative of a sound of at least the first wheel moving on a surface.

10. The control system of claim 9, wherein the one or more processors are further configured to process the audio input to determine if the audio is indicative of a traction aid fitted to the first wheel.

11. The control system of claim 1, wherein the one or more processors are further configured to receive at least one input signal indicative of a size, or a change of size, of each one of a plurality of wheels per axle of the vehicle.

12. The control system of claim 1, wherein the one or more processors are further configured to receive at least one input indicative of a size, or a change of size, of each of the plurality of wheels of the vehicle.

13. A vehicle comprising the control system of claim 1.

14. A method for controlling a vehicle, the vehicle comprising a plurality of wheels and an adaptive suspension system, the method comprising:
receiving at least one input signal indicative of a size, or a change of size, of at least a first wheel of the plurality of wheels; and
determining if there has been an increase in the size of at least the first wheel in dependence on the at least one input signal; and
when it is determined that there has been an increase in the size of at least the first wheel, outputting a control signal to reduce a maximum wheel travel of the adaptive suspension system.

15. A non-transitory computer readable medium comprising computer readable instructions that, when executed by a processor, cause performance of the method according to claim 14.
